(19) United States
(12) Patent Application Publication
(10) Pub. No.: US 2008/0010014 A1
(43) Pub. Date: Jan. 10, 2008

(54) MODULAR NAVIGATION SYSTEM FOR MEDIA PLAYER

(75) Inventors: Philipp Hess, Grosshansdorf (DE); Uwe Schindler, Randersacker (DE)

Correspondence Address: BLAKELY SOKOLOFF TAYLOR & ZAFMAN, 1279 OAKMEAD PARKWAY, SUNNYVALE, CA, 94085-4040, US

(73) Assignee: Navigon AG, Hamburg (DE)

(21) Appl. No.: 11/761,256

(22) Filed: Jun. 11, 2007

Related U.S. Application Data
(60) Provisional application No. 60/804,992, filed on Jun. 16, 2006.

(51) Int. Cl. G01C 21/00; G06F 17/30

(52) U.S. Cl. 701/211

(57) ABSTRACT

The present invention relates to a navigation apparatus and a method for outputting navigation instructions. The navigation apparatus comprises a navigation unit (2), a position determination apparatus, a processor apparatus having an operating memory, a mass memory apparatus for receiving a data bank, a display apparatus, an operating element configuration, a sound output apparatus, and navigation software.

The present invention is distinguished in that the display apparatus and operating element configuration are situated separately in a mobile multimedia playback device (1). The present invention allows a combination of the two separate device and service species “navigation” and “personal multimedia” by expanding the area of use of multimedia playback devices and associated provider services to the field of navigation. The operating interface familiar to the user and the familiar access to the data and services of the service provider are also maintained for the new area of application of navigation. Furthermore, hardware costs are saved and operation is simplified by unifying the user interfaces.

The present invention relates to a modular navigation apparatus for a media player according to claim 1 and a method for outputting navigation instructions according to claim 15.

The propagation of portable media players or multimedia playback devices has increased continuously in recent years because of the rising performance capability of the devices and improvements of the associated services. More and more consumers carry portable media players of this type with them, above all when they move outside the domestic environment, for example, when traveling, in public transportation, or in motor vehicles.

However, there is often not only a need of the user for musical entertainment using a portable multimedia playback device of this type when underway, but rather, precisely in this case, support is frequently also needed in orientation and location finding in unknown environments. For this purpose, manifold forms of navigation devices already exist, which are either designed as portable handheld devices or are provided for installation in motor vehicles, for example.

Users of such devices, who frequently both carry a portable media player with themselves and also regularly use a navigation device, have generally been forced up to this point to carry along and/or have to operate separate and completely different devices for the different purposes of “media entertainment” and “navigation”.

This is not only disadvantageous because of the multiple devices to be carried along, but rather also because of the necessity of adjusting oneself to the differing operations of these devices, and/or learning their operation in the first place. When underway, handling and changing between multiple devices for different purposes is additionally cumbersome, or may even result in a safety problem, in particular if, when traveling in a motor vehicle, the concentration of the driver is distracted from the street events by the operation of the various devices.

Finally, the necessity given in the prior art of having to provide and carry along separate devices for media entertainment and navigation results in largely identical hardware which is unnecessarily present and paid for by the consumer multiple times; such as processors, operating elements, display screens, device housings, etc.

With this background, it is the object of the present invention to provide a modular navigation apparatus and a method for outputting navigation instructions, by which the cited disadvantages present in the prior art are overcome. In particular, the present invention is to allow combination which is as close as possible of the device equipment of the portable media player and the compact navigation devices, which has been separate up to this point, for the user.

This object is achieved by a navigation apparatus according to claim 1 and by a method according to claim 15.

Preferred embodiments are the subject matter of the subclaims.

The navigation apparatus according to the present invention comprises, in a way initially known per se, a navigation unit having a position determination apparatus particularly comprising a GPS receiver, a processor apparatus having an operating memory, a mass storage memory for receiving a databank having geographic data, also a display apparatus, an operating element configuration, an apparatus for sound output, and navigation software receivable in the operating memory and/or in the processor apparatus.

However, according to the present invention the navigation apparatus is distinguished in that the display apparatus and operating element configuration are situated separately from the navigation apparatus in a mobile multimedia playback device or media player.

In this way, firstly advantageous functional unification is achieved. This is because the area of application of a mobile media player which is frequently present or may be provided by the user may be significantly enlarged—using the expansion according to the present invention by a navigation unit—in the form that the media player may additionally also be used as the control center for the mobile navigation.

Therefore, a further field of use for the media player may be opened up by the navigation unit, which is implemented as a “navigation accessory part” for an already existing media player or a media player available on the market, for example. In particular, the already known or familiar operating concept of the media player may be maintained and/or expanded for the user to the field of use of navigation, that is to say, the user does not have to learn a further operating concept, but rather may perform both media access and also navigation via the uniform user interface of the media player without media fracture.

Moreover, the cumulative hardware costs are reduced in comparison to separate navigation solutions to be provided in addition to the media playback device, because instead of additional and/or proprietary hardware for navigation, a majority of the hardware already provided with the media player may be used, in particular the display screen, housing, sound reproduction apparatus, and operating elements of the media player.

Finally, services and/or access pathways to provider-side databanks which already exist may advantageously also be used and/or expanded to the field of geographic navigation data, associated software, and added-value services linked thereto, for example.

To implement the present invention, it is initially not relevant in which way the constructive or data coupling and/or output division between media player and navigation unit occurs, as long as the operability of the navigation functions via the user interface of the media player is ensured.

However, according to an especially preferred embodiment of the present invention, lists of navigation targets and associated control characters for controlling navigation functions are converted into a list format compatible with the media play list format of the multimedia playback device and stored in this format in the operating memory or mass memory of the navigation apparatus. This embodiment has the special advantage that lists of navigation targets may be displayed precisely like typical media play lists on a display of the media player.

The user may thus search through the lists of possible navigation targets in the way familiar from media usage via the operating elements of the media player and select the desired element and/or navigation target. This way, first of all, no modification of the media player operating system or even the hardware of the media player is necessary for this purpose, to also display navigation targets on the display of the media player in addition to media titles and be able to search and select them via the operating elements of the media player.

According to a further, preferred embodiment of the present invention, the navigation apparatus also comprises a apparatus for converting a route guide graphic into a graphic format compatible with the output graphic format of the multimedia playback device. In this way, route guide graphics may also be output via the display screen of the media player with hardware and software of the media player which is unchanged as much as possible. Moreover, in this case practically no additional processor performance of the media player is needed for displaying and/or outputting the route guide graphics.

According to a further preferred embodiment of the present invention, the navigation unit comprises a apparatus for transmitting the audio signal delivered by the multimedia playback device to an external loudspeaker system. This embodiment is advantageous in particular because in this way, when the navigation apparatus according to the present invention is used in a motor vehicle, for example, music from the media player may be mixed with the acoustic navigation instructions generated in the navigation unit, and may then be replayed via e.g. external loudspeakers, in particular via loudspeakers already installed in a vehicle.

Furthermore, thanks to this embodiment, the replay volume of both the navigation instructions from the navigation unit and also the music from the media player may be controlled and adapted as needed entirely by the navigation unit. In particular, the volume of the music replay may be reduced automatically as navigation instructions are stated, for better understandability.

In a further embodiment of the present invention, the mass memory apparatus of the navigation apparatus is situated in the multimedia playback device. Thanks to this embodiment, further savings may be achieved in the hardware costs, because in this way navigation data and/or navigation software may be received in particular in the already existing mass memory—for example in the hard drive or the flash memory of the media player. A separate external mass memory or a mass memory to be situated in the navigation unit for implementing the auxiliary function “navigation” for the media player may thus be dispensed with.

According to an especially preferred embodiment of the present invention, the navigation unit has a transmission interface compatible with the standardized interface of the multimedia playback device. In this way, the media player may be connected simply and rapidly to the navigation unit when the media player is to be used for navigation purposes. The media player may also be disconnected simply and rapidly from the navigation unit when it is to be used separately and solely for media replay purposes again. The embodiment of the navigation unit having an interface compatible with the standardized interface of the media player is also advantageous because existing media players or media players on the market may thus be combined with the navigation unit without modification of their hardware.

With this background, in a further embodiment of the present invention, the transmission interface between media player and navigation unit is a wireless interface. In this way, data may be transmitted without contact between media player and navigation unit, which simplifies the coupling between media player and navigation unit for the purpose of using the media player for navigation even further. This is because it suffices to solely bring the media player into proximity to the navigation unit to be able to also use the navigation functions via the operating interface of the media player. In particular, the media player may thus be connected especially simply with a corresponding holder on the dashboard for the exemplary case of use in a motor vehicle without proper seating of a mechanical data transmission interface having to be ensured.

According to a preferred embodiment of the present invention, the navigation unit is installed in a motor vehicle. In other words, this embodiment means that the portable media player thus represents a part of a navigation apparatus for a motor vehicle. Firstly, cost savings result in this way in the vehicle equipment, because the outlay above all for a separate display apparatus and further additional operating elements of the navigation apparatus may be dispensed with. Furthermore, this embodiment has the advantage that the operating concept familiar to the user of the media player may thus also be applied for the purpose of navigation in the motor vehicle. Finally, an advantageous synergy affect results because of the possibility of being able to play back both the personal music collection and also—possibly simultaneously—operating the vehicle navigation using the media player in the vehicle.

Moreover, improvement of the safety in traffic may also be achieved, because in this way navigation and media access occurs via the familiar simple and uniform operating interface of the media player.

According to a further embodiment of the present invention, the navigation unit comprises an operating element for changing over the multimedia playback device between the media playback operation and the navigation operation. This embodiment particularly has the advantage of simple and cost-effective ability to change over the combination according to the present invention of media player and navigation accessory part. In particular, a media player may be connected, practically without any changes to the player hardware and with no or only minimal changes to the player software, to the navigation unit and/or the navigation accessory part and used as the operating interface for the navigation thanks to this embodiment. This is because the required changeover between media playback operation and navigation operation may be performed using the additional operating element situated on the navigation unit thanks to this embodiment, because of which no additional operating element and no modifications on the media player are needed for the changeover.

According to a further embodiment, the operating element for changing over the media player between media playback operation and navigation operation is situated on a remote-control unit. In this way, the possibility results in particular of more flexible configuration and more compact design of the navigation unit. Because, thanks to this embodiment, operating elements on the navigation unit itself may be completely dispensed with if necessary, the navigation unit may be designed and situated especially flexibly, for example, it may have the external form of a simple holder for the media player.

According to an especially preferred embodiment of the present invention, the multimedia playback device is set up for simultaneous media playback operation and navigation operation. This is advantageous because the user may thus play back media and/or audio using the media player in the typical way, the operation and control of the navigation unit however being able to be performed simultaneously via the operating interface of the media player. In other words, this means that the media playback operation of the media player does not have to be left completely or even interrupted when controlling the navigation using the user interface of the media player.

In a further embodiment of the present invention, the navigation unit is implemented as a holder for the multimedia playback device. In this way, the navigation unit may be designed as a compact device, for example, in the form of a docking station for the media player; especially cost-effective and simple possibilities result for producing and mounting the navigation unit implemented as a holder, in particular in a motor vehicle.

With this background, according to a further embodiment, the navigation unit comprises a holder for the multimedia playback device and a separate control unit. Thus, the holder for the media player may be implemented in an even more compact and space-saving way, because the complete electronics of the navigation unit are housed in a separate control unit, for example. The latter may in turn be installed at any arbitrary point in the motor vehicle, for example.

In a further embodiment of the present invention, processor apparatus and operating memory of the navigation apparatus are situated in the multimedia playback device. In this way, outlay and costs for the hardware of the navigation unit may be significantly reduced even further, because thus operating memory and CPU of the media player may additionally also be used for processing the navigation tasks. In other words, this embodiment means that the navigation software runs on the media player as the hardware platform itself, because of which no separate CPU and no separate operating memory still have to be provided for implementing the navigation functions in the navigation unit, which is implemented as a navigation accessory for the media player.

The navigation unit may thus essentially be reduced to a holder and/or coupling device for the media player, the position determination apparatus, in particular the GPS receiver, and possibly an interface for transmitting audio data to external loudspeakers, in particular vehicle loudspeakers.

Other task divisions between the navigation unit and a media player are also possible. Thus, for example, the memory for the navigation software and/or an unit for rendering the maps may be situated in the navigation unit, while the remaining components of the navigation apparatus are situated in the media player.

The present invention also relates to a method for outputting navigation instructions of a navigation apparatus. The navigation apparatus comprises a navigation unit having a position determination apparatus, a processor apparatus having operating memory, a mass memory apparatus, a display apparatus, an operating element configuration, and also a sound output apparatus and navigation software receivable in the operating memory and/or in the processor apparatus. The display apparatus and operating element configuration of the navigation apparatus are situated in a separate mobile multimedia playback device.

The method according to the present invention comprises the method steps described in the following.

Firstly, in a first method step, geographic datasets are provided by a provider on a data carrier, in particular digital street maps, as well as lists of target addresses.

In the simplest case, this may be the provision of the geographic datasets using a mobile data carrier, for example, using a CD/DVD or a flash memory card (e.g., SD cards), which may be read out on the user side by suitable software, preferably in the navigation unit. Alternatively or additionally however, online retrieval of the geographic datasets from an (Internet) server is also provided.

In a further step, a number of the geographic datasets and/or target addresses provided by the provider are retrieved from the data carrier—i.e., from the mobile data carrier or the server—on the user side using a client system.

In a further method step, the retrieved geographic datasets and/or target addresses are transmitted to a mobile multimedia playback device. Subsequently, a list of target addresses is displayed on the display of the multimedia playback device.

The user then selects one of the displayed target addresses using the operating elements of the multimedia playback device, and the selected target address is transmitted to the processor apparatus of the navigation apparatus by the multimedia playback device.

Subsequently, graphic, text, and/or acoustic route guide instructions are generated by the navigation software and finally replayed using the multimedia playback device.

The method according to the present invention thus particularly allows a focused service-based offering of navigation services, because, according to the present invention, thanks to the double usage of the media player which is present anyway and/or obtainable as an operating interface and input and output device for target addresses and/or navigation instructions, the additional required hardware is minimized in relation to the navigation devices known from the prior art.

Thanks to the method according to the present invention, the field of use for personal portable media players, and possibly also for the associated online services, is synergistically expanded to the field of navigation. The user does not simultaneously have to learn a further operating concept, however, because the operation of the navigation also occurs via the known, familiar interface of the media player.

The present invention is primarily implemented independently of where and on what type of data carrier the data is provided by the provider in the initial method step, as long as the data carrier has sufficient capacity and may be made accessible to the user. According to a preferred embodiment of the method according to the present invention, the geographic datasets and/or target addresses are provided on a data carrier of a provider-side computer server using an access service, however.

This embodiment provides the decisive advantage that in this way a service which is possibly already established for retrieving datasets, in particular an online service for retrieving audio or multimedia data from a provider-side server, may be expanded to the additional, integrated data and service offering of the navigation.

For the user, this offers the great advantage that he therefore may not only purchase his media needs, but rather may also purchase current navigation data via the already known or familiar online access service at any time. In this way, an online service already provided by a provider may be supplemented and expanded with significant additional value exploitation possibilities by integrating the navigation offerings.

According to a preferred embodiment of the present invention, in method step b), a set of geographic datasets and/or target addresses definable by the user is retrieved. This corresponds to the dealings of the user with downloading multimedia files from a provider-side server, which is frequently already familiar. Therefore, only those datasets or lists of target addresses which are of interest to and/or are needed by the user are selectively retrieved.

With this background, according to further preferred embodiments of the method according to the present invention, access to and retrieval of the geographic datasets and/or target addresses in method step b) occurs following a personal identification of the user, and/or the retrieval of the datasets or target addresses is fee-based as a function of the scope of the datasets retrieved.

For the user, thanks to the user identification, the offerings of downloadable datasets may thus be particularly permanently tailored by the provider to the personal preferences of the user, and additional content about leisure time offerings, culture, or events may be provided to the user which is especially tailored to his interests. Thanks to the personal user identification and via fee-based content, the provider may simultaneously optimize the customer connection and generate the sales necessary for operating the service.

According to a further embodiment of the method according to the present invention, a specific scope of geographic datasets and/or target addresses is stored on the mass memory of the navigation apparatus—independently of the scope of the downloads performed by the user from provider-side data carriers and/or servers. However, in method step e), only those datasets and/or target addresses stored in the navigation apparatus may be selected by the user and/or be used for navigation which are additionally contained and/or listed in a fee-based download of the user from the provider-side data carrier or computer server.

In this way, geographic data for a larger area may be preinstalled, in particular already by the producer, on the navigation apparatus and/or on an associated mass memory, for example, on a flash memory card, the user only being able to access the geographic data, street maps, and/or lists of target addresses for which he has purchased the possibly fee-based usage rights via the online service. Furthermore, it is thus possible to minimize the data quantity to be downloaded by the user, because essentially only lists of target addresses and possibly updates to street maps and/or software have to be downloaded, the majority of the data already being present on the mass memory of the navigation apparatus independently of the usage rights of the user, however.

According to a further preferred embodiment of the method according to the present invention, the retrieval of the geographic datasets and/or target addresses in method step b) is fee-based as a function of the actual scope of datasets used. This embodiment is advantageous because in this way usage fees only arise for those geographic datasets or lists of target addresses which have actually been used by the user for the purpose of navigation. This opens up the possibility for the user, for example, of initially acquiring a larger scope of geographic datasets or target addresses from the provider in the meaning of a reserve supply, usage fees only being charged for the scope of data, however, which has not only been downloaded, but rather also actually used for navigation.

According to a further embodiment of the method according to the present invention, in method step b), there is also a version number comparison between the geographic datasets, target address lists, and/or navigation software versions stored on the user-side client system and/or on the mobile multimedia playback device with the version of the datasets, target address lists, and/or the navigation software currently present at the provider. There is an update of the data and/or software versions present with the user to the particular newest versions present at the provider if necessary.

In this way, the navigation software present at the user and/or the navigation data, target address lists, or street maps stored at the user may each be brought to the most current state—after corresponding user actuation or automatically. This is advantageous and significant in particular in embodiments of the present invention which comprise an online connection to a data carrier on a provider-side server as needed.

According to a further preferred embodiment of the method according to the present invention, the user-side client system is formed by a personal computer of the user. The retrieval and transmission of the geographic datasets and/or target addresses in method steps b) and c) are performed using the personal computer. This embodiment is advantageous in that the personal computer represents one of the established access pathways for online services, in particular for music or multimedia download services. Services of this type may thus also be expanded to navigation content easily and in a way transparent to the user. Furthermore, the storage of the navigation contents, like the multimedia contents, may occur temporarily or permanently on the personal computer of the user. Partial sets of the navigation content downloaded by the user may be transferred from the personal computer of the user to the navigation unit and/or to the media player as needed—as is also typical for multimedia content—in particular for mobile use when traveling.

According to an alternative embodiment of the method according to the present invention, the user-side client system is formed by the navigation unit. The geographic datasets and/or target addresses are retrieved and transmitted in method steps b) and c) using the navigation unit. This embodiment is particularly advantageous and significant for the case of an extensively independent navigation unit, which may be implemented as a navigation accessory part for an existing media player, for example. In this case, the retrieval of the datasets and/or target addresses and the transmission to the mass memory of the navigation unit or the media player may particularly be performed by a flash memory card provided by the provider, which is inserted into a corresponding slot of the navigation unit for this purpose.

In an especially preferred embodiment of the method according to the present invention, the geographic datasets and/or target addresses are converted by the provider into a playlist format of the multimedia playback device and stored on the data carrier. The datasets and/or target addresses are displayed in method step d) in the playlist format on the display of the multimedia playback device.

This embodiment is especially advantageous because of the minimization of required changes on hardware and/or software of the media player thus made possible, if it is to experience the transformation into a navigation system. This is because, thanks to the conversion of the geographic datasets and/or target addresses into the typical playlist format of the media player, the geographic datasets and/or target addresses may be displayed without further measures on the media player and searched and/or selected in the way familiar to the user via the operating elements of the media player.

According to a further especially preferred embodiment of the method according to the present invention, the graphic route guide instructions are generated in method step g) in a graphic format compatible with the output graphic format of the multimedia playback device.

This embodiment also serves for optimum compatibility of the method according to the present invention with extensively unaltered hardware and/or software of the media player. Because in this way the already existing routines in the media player may essentially be used, there is also a minimization of the processing power of the media player required for the additional navigation function, for example.

Finally, in a further embodiment of the present invention, in method step a), the retrieval of additional geographic linked content occurs. This additional content may particularly comprise information about points of interest, current events, and other cultural content or content related to the interests of the user.

This embodiment is especially advantageous in that a media player restricted up to this point solely to media replay may become a bundled interface of media entertainment, navigation, and geographically-related cultural activity in this way.

In the following, the present invention is explained in greater detail on the basis of drawings which solely illustrate exemplary embodiments.

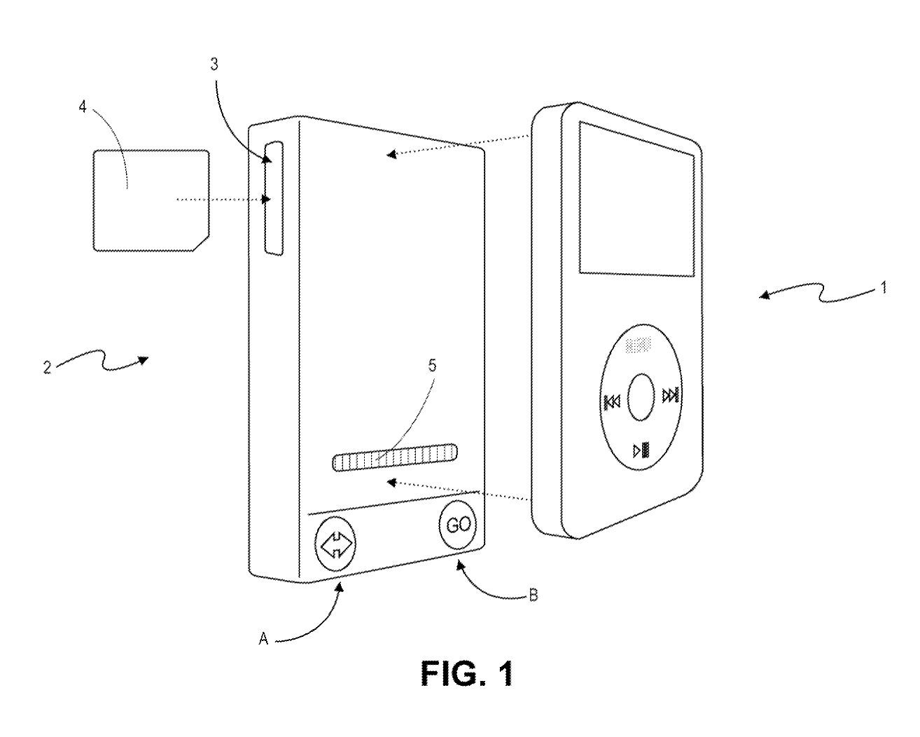

FIG. 1 shows a schematic illustration of an exemplary embodiment of a navigation apparatus according to the present invention having a navigation unit and a media player;

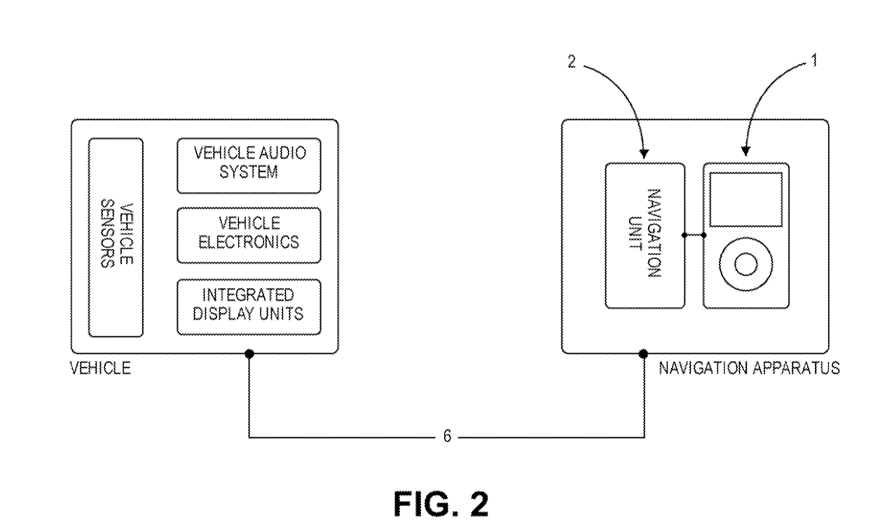

FIG. 2 shows a schematic diagram of a configuration of components of the navigation apparatus from FIG. 1 and a motor vehicle;

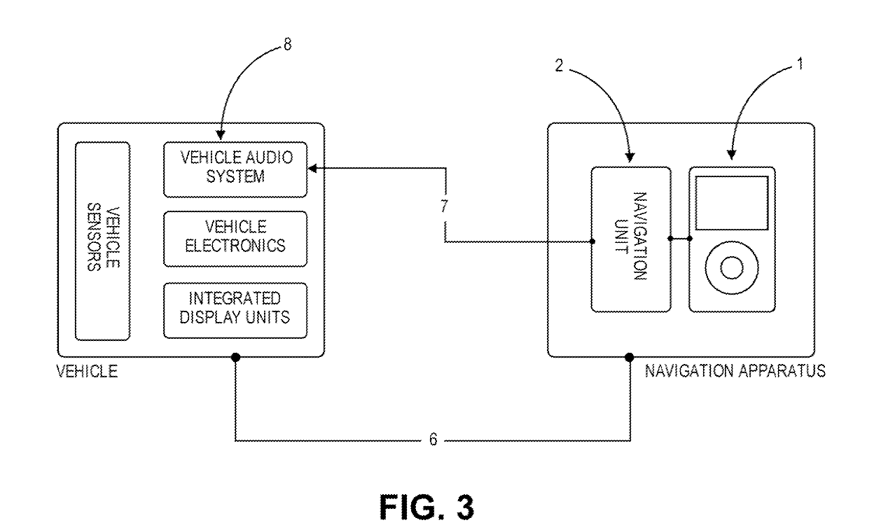

FIG. 3 shows, in an illustration corresponding to FIG. 2, the component configuration from FIG. 2 having a variant of the audio transmission;

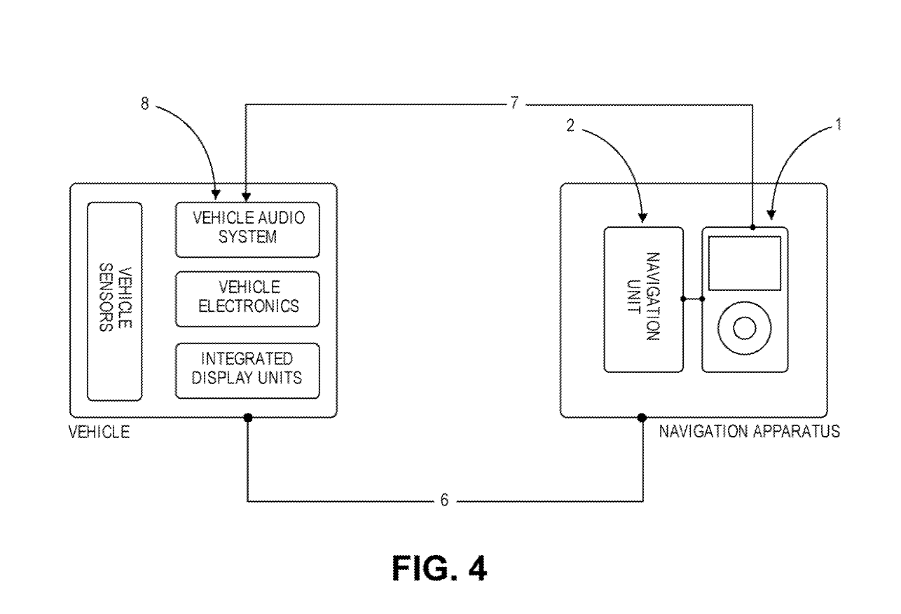

FIG. 4 shows, in an illustration corresponding to FIGS. 2 and 3, the component configuration from FIGS. 2 and 3 having a further variant of the audio transmission;

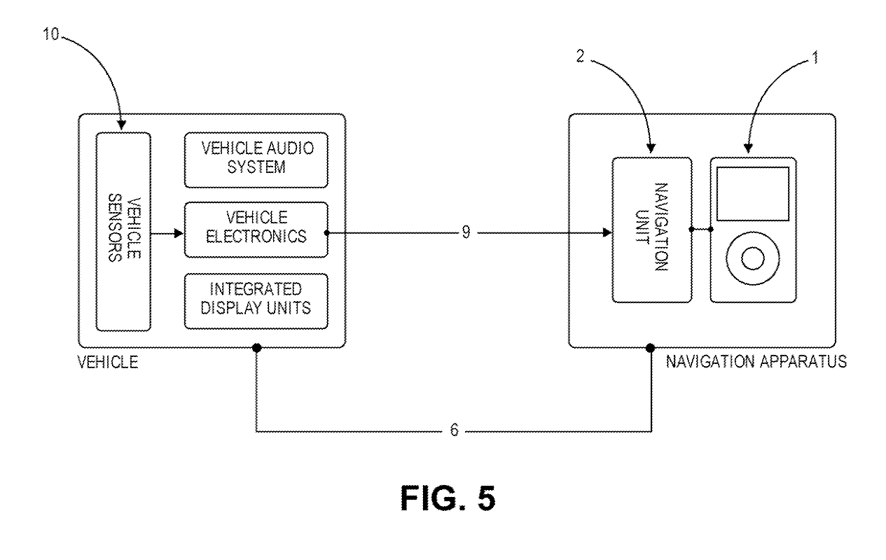

FIG. 5 shows, in an illustration corresponding to FIGS. 2 through 4, the component configuration from FIGS. 2 through 4 having an example of the transmission of sensor signals between vehicle and navigation apparatus;

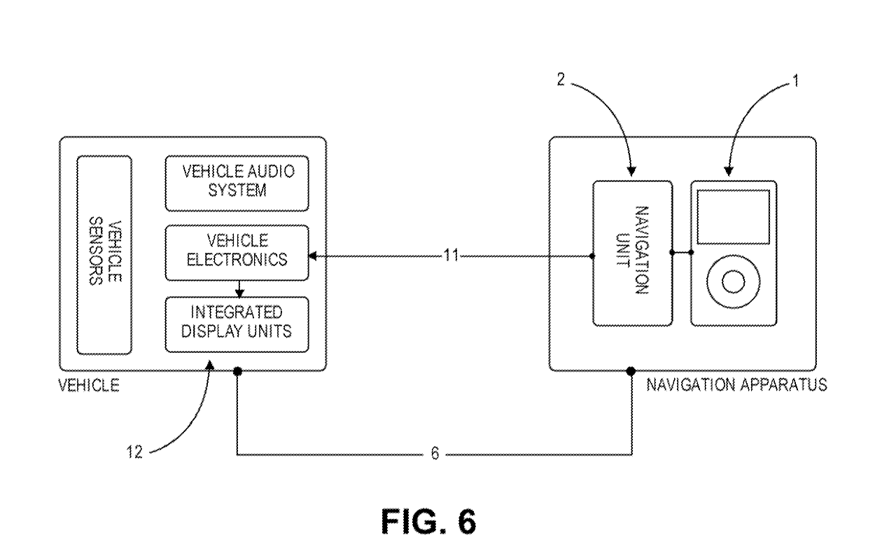

FIG. 6 shows, in an illustration corresponding to FIGS. 2 through 5, the component configuration from FIGS. 2 through 5 having an example of the output of navigation instructions via the motor vehicle;

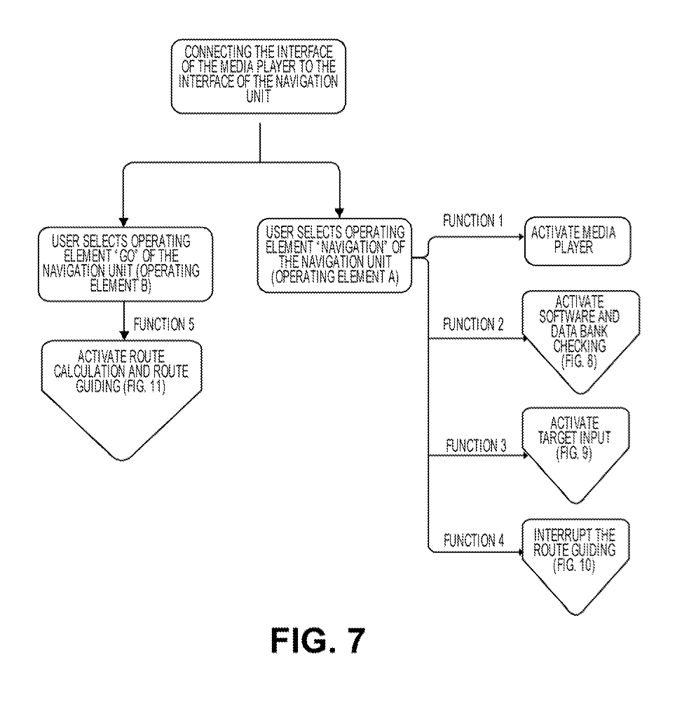

FIG. 7 shows a schematic flowchart of an exemplary embodiment for the method according to the present invention for outputting navigation instructions, the basic user operation is shown here;

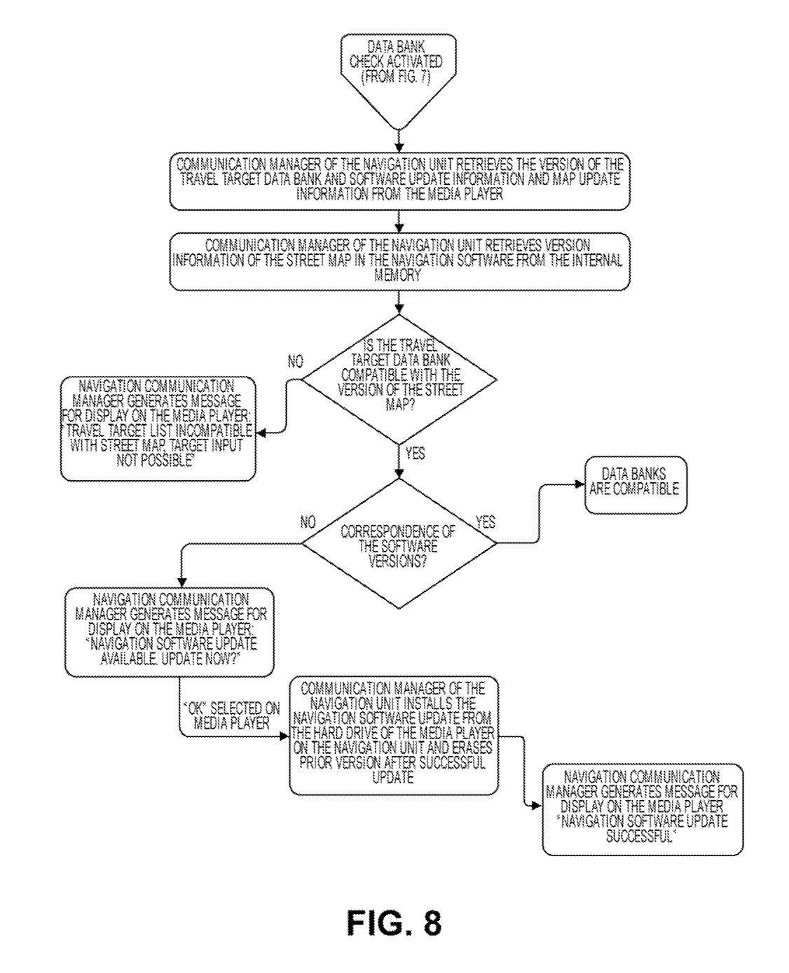

FIG. 8 shows, in a flowchart corresponding to FIG. 7, the method steps during the databank update of an exemplary embodiment of a method according to the present invention for outputting navigation instructions;

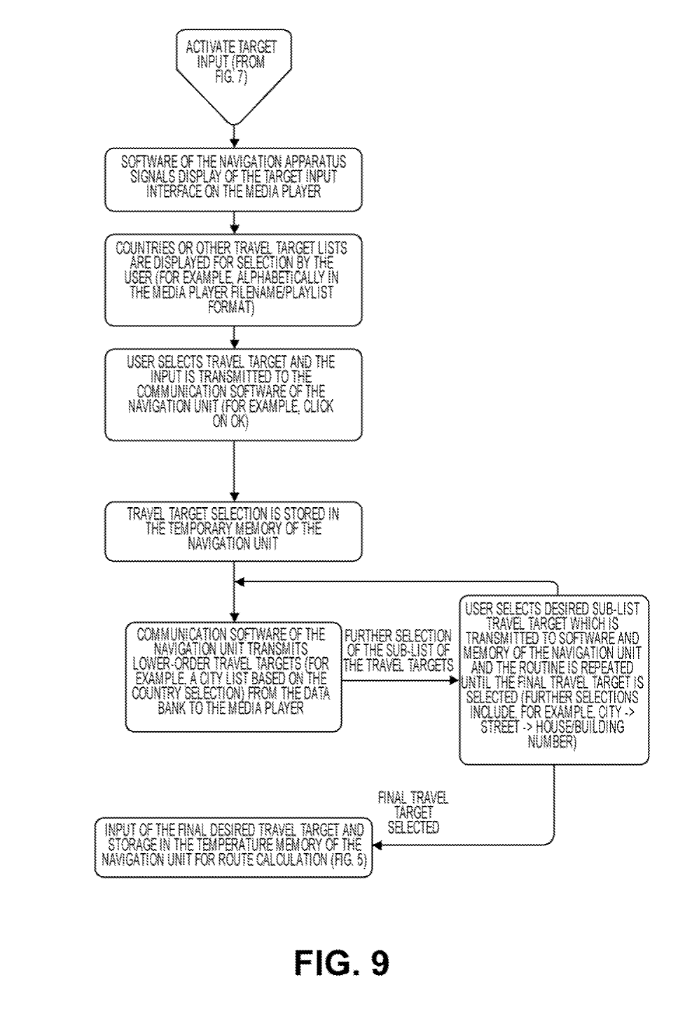

FIG. 9 shows, in a flowchart corresponding to FIGS. 7 and 8, the method steps for the target input via the media player in an exemplary embodiment of a method according to the present invention for outputting navigation instructions;

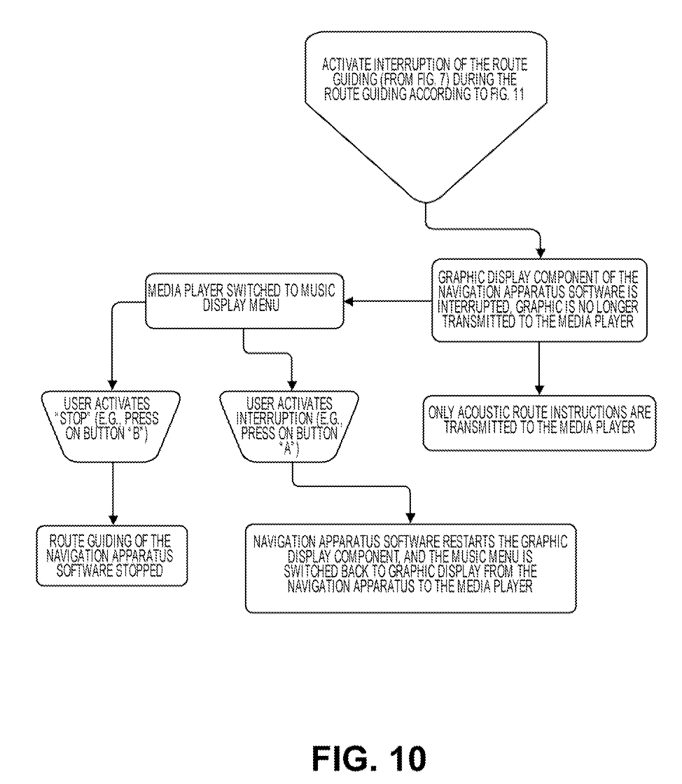

FIG. 10 shows, in a flowchart corresponding to FIGS. 7 through 9, the method steps upon the interruption of the route guiding, and/or upon the changeover to the media replay, in an exemplary embodiment of a method according to the present invention for outputting navigation instructions;

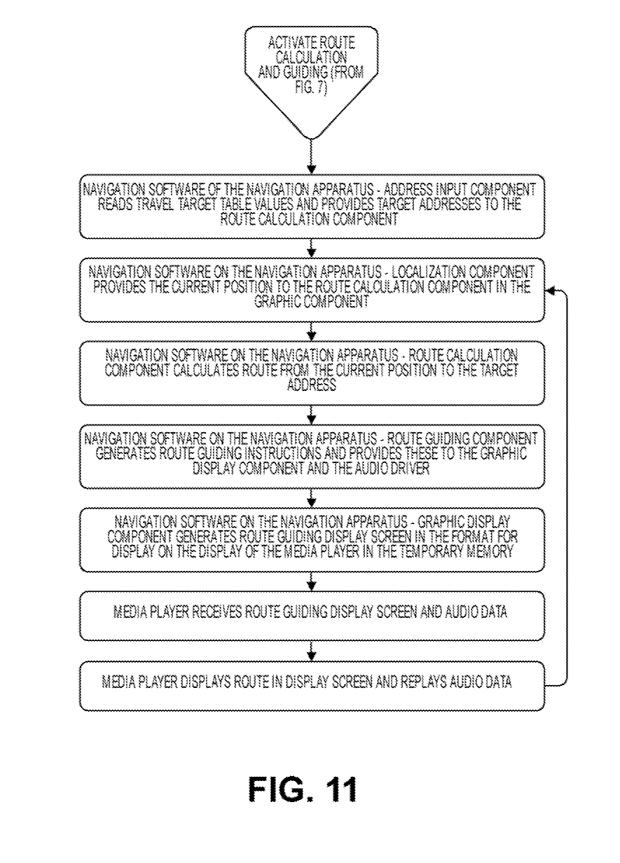

FIG. 11 shows, in a flowchart corresponding to FIGS. 7 through 10, the method steps of route calculation and outputting the route guide instructions in an exemplary embodiment of a method according to the present invention for outputting navigation instructions;

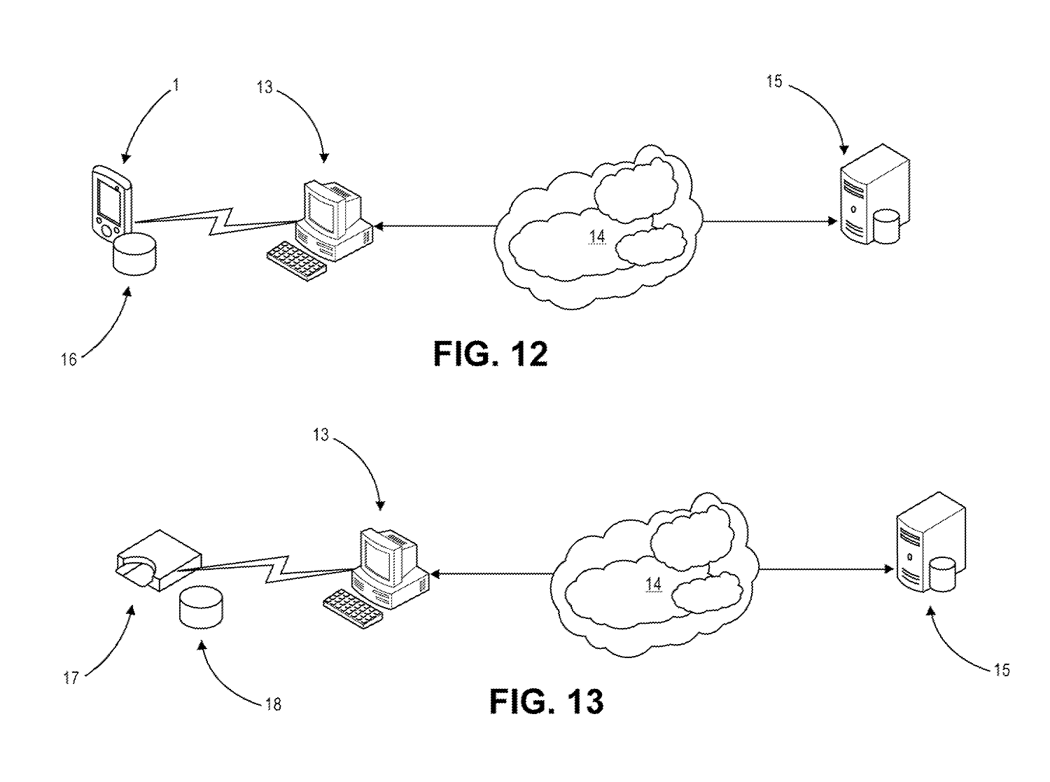

FIG. 12 shows, in a schematically illustrated configuration of components, a variant of the sequence of an online update in an embodiment of the navigation apparatus according to the present invention;

FIG. 13 shows, in an illustration corresponding to FIG. 12, the component configuration from FIG. 12 in a further variant of the sequence of an online update;

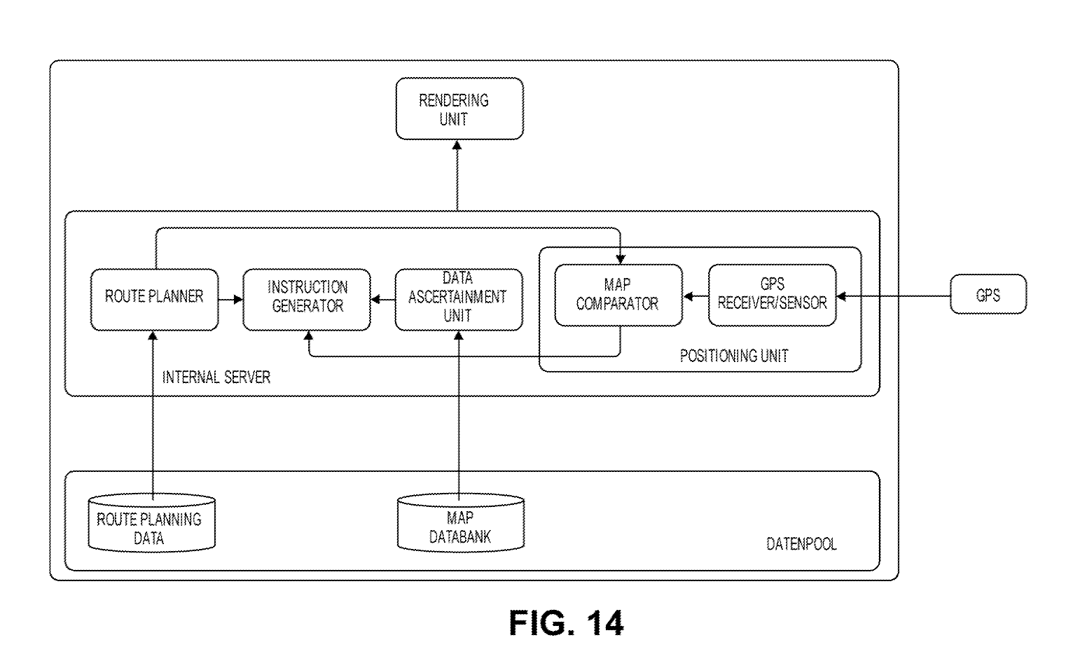

FIG. 14 shows, in a schematically illustrated configuration, the components used for route calculation of an embodiment of a navigation apparatus according to the present invention;

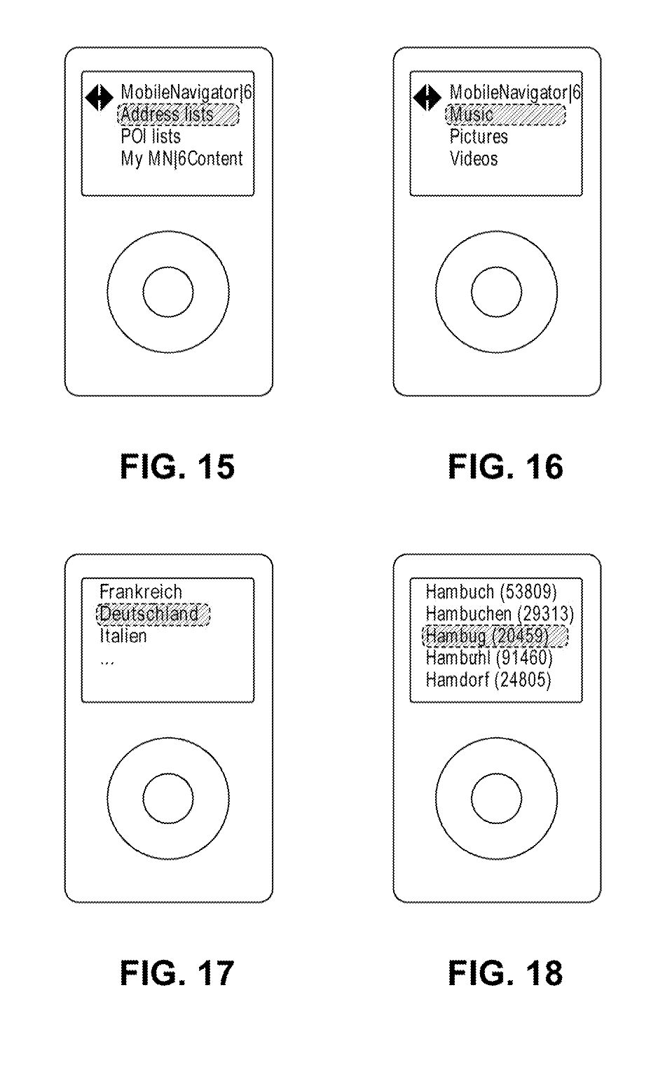

FIG. 15 shows, in a schematic view, the media player for an embodiment of a navigation apparatus according to the present invention during the selection from various travel target lists;

FIG. 16 shows, in an illustration and view corresponding to FIG. 15, the media player of an alternative embodiment of a navigation apparatus according to the present invention upon the selection between different usage capabilities of the media player;

FIG. 17 shows, in an illustration and view corresponding to FIGS. 15 and 16, the media player from FIG. 15 or FIG. 16 during the country selection in the framework of the target input;

FIG. 18 shows, in an illustration and view corresponding to FIGS. 15 through 17, the media player from FIG. 17 during the selection of the city in the framework of the target input;

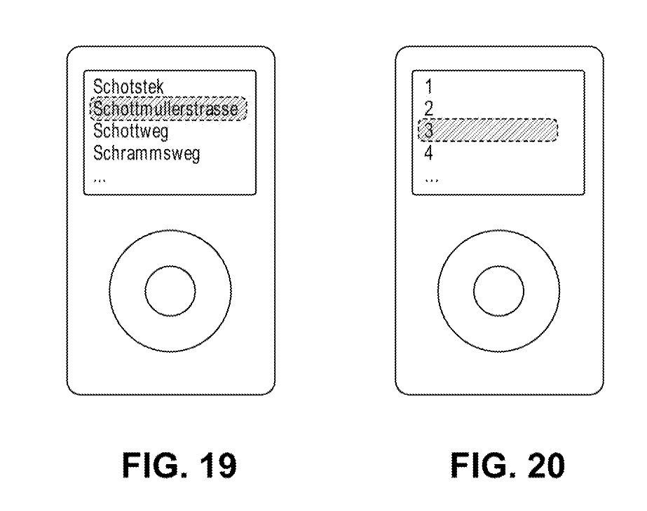

FIG. 19 shows, in an illustration and view corresponding to FIGS. 15 through 18, the media player from FIGS. 17 and 18 during the selection of the street in the framework of the target input; and

FIG. 20 shows, in an illustration and view corresponding to FIGS. 15 through 19, the media player from FIGS. 17 through 19 during the selection of the street number in the framework of the target input.

FIG. 1 shows, very schematically, an embodiment of a navigation apparatus according to the present invention.

Firstly, a media player 1 and a navigation unit 2 having a memory card reader 3 and having an associated memory card 4 are shown. The navigation unit 2 has an interface 5 connectable to the standard interface of the media player 1 as well as two operating buttons “A” and “B” in the exemplary embodiment shown.

The navigation unit 2 is intended, for example, for attachment in a motor vehicle, but may also be implemented as a pocket-sized portable device. According to the present invention, the navigation unit 2 is particularly used for supplementing an already provided and/or commercially available media player 1, to not only be able to access multimedia such as music or videos using the media player 1 in this way, but rather also be able to additionally use the media player 1, including its operating interface and its actuating elements, as a navigation device.

Firstly, to manage with no or only minimal changes to software and/or hardware of the media player 1, the navigation unit 2 is equipped according to the exemplary embodiment shown with a separate mass memory in the form of the card reader 3 and the memory card 4 receivable therein. This allows the accommodation of extensive navigation databanks, travel target lists, and digitized street maps in the navigation apparatus, even if the mass memory of the media player 1 is not to be suitable for this purpose because of a lack of compatibility or because it is too small.

The individual components of the navigation apparatus, in particular the processor and operating memory used for route calculation, the mass memory having the navigation-related databanks, the navigation software, and the sound output apparatus may be distributed in different ways on the media player 1 and navigation apparatus 2. To be able to also use an existing or commercially available media player 1 for navigation purposes practically without modifications, all cited components may be situated in the navigation unit 2.

The embodiment of the navigation apparatus according to the present invention illustrated in FIG. 1 is thus particularly distinguished in that it may be used together with a commercially available media player 1, because of which the media player 1 is solely used as an input user interface for selecting and inputting the desired travel target, as well as an output device for graphic and possibly acoustic navigation instructions. All navigation-related calculation steps and data movements are performed completely in the navigation unit 2, however.

Because the commercially available, unmodified media player 1 does not have any operating elements of its own for activating the navigation functions, or for changing over from media playback operation to navigation operation, the navigation unit 2 in FIG. 1 is equipped with the two operating elements “A” and “B”. The button “A” is used for changing over between navigation function and media playback operation, while in contrast the button “B” starts the navigation calculations after the desired travel target has been input via the operating interface of the media player 1. The corresponding sequences for this purpose are illustrated in more detailed form in FIGS. 7 through 11.

In other embodiments of the navigation apparatus according to the present invention, however, multiple or all of the above-mentioned components of the navigation apparatus may be situated not in the navigation unit 2, but rather in a (possibly modified) media player 1.

Thus, for example, in an alternative embodiment of the present invention, the processor, the operating memory, and the mass memory of the media player 1 are also used for executing the navigation calculations and for storing the navigation-related databanks, and the sound output of the acoustic route guiding instructions is also performed via a corresponding audio output apparatus of the media player 1. In this case, additional operating elements such as the buttons “A” and “B” on the navigation unit 2 in particular may be dispensed with.

FIG. 2 shows a schematic diagram illustration of the basic components of the navigation apparatus from FIG. 1 (on the right in the drawing) as well as further components possibly usable in the scope of navigation and situated in a motor vehicle (on the left in the drawing).

It may also be seen that the navigation apparatus comprises the navigation unit 2 and the media player 1 connectable to the navigation unit 2, the media player 1 particularly forming the user operating interface for the navigation functions.

In the exemplary embodiment shown in FIG. 2, firstly the mechanical connection 6 between the motor vehicle and the navigation apparatus is symbolized. The connection 6 may, for example, be produced in a form in which the navigation unit 2 itself is attached temporarily or permanently in particular in the area of the dashboard of the motor vehicle and thus forms a holder for the media player 1.

The media player 1 may thus always be carried along by the user in a pocket when underway, for example, and used in the typical way. For usage in a motor vehicle, in particular for the purpose of operating the navigation apparatus in a motor vehicle, the media player 1 may be engaged on the navigation unit 2 attached in the vehicle, a mechanical connection and also an electrical connection being produced between navigation unit 2 and media player 1 simultaneously using the interface 5 of the media player 1.

Two different variants of the audio output 7 in a navigation apparatus according to the present invention are shown in FIGS. 3 and 4. In the exemplary embodiment of FIG. 3, the output 7 of the spoken navigation instructions which have been generated in the navigation apparatus occurs via a direct connection between the navigation unit 2 and the audio system 7 of the motor vehicle. In contrast, in the exemplary embodiment of FIG. 4, the spoken navigation instructions are conducted via the existing amplifier and the audio output of the media player 1, and go from there to the audio system 8 of the motor vehicle, thus, for example, to an automobile radio provided in the vehicle and/or to the motor vehicle loudspeakers. The audio signals output by the media player 1, predominantly music, are also transmitted to the audio system 8. Audio management and/or prioritization management functions are preferably employed, using which the changeover between media output and output of navigation instructions may occur softly. Priority switching in regard to the type of the audio output signal may also occur. This comes into consideration in particular if the media player is additionally equipped with a radio function, using which traffic reports may be recognized, for example.

FIG. 5 shows in what way a navigation apparatus according to the present invention may access the sensors 10 possibly provided in the motor vehicle using a data connection 9—for the purpose of supporting the navigation function. The motor vehicle sensors 10 may particularly be GPS receivers, steering angle sensors, magnetic field sensors, and/or a speedometer tap. This embodiment increases the precision of the navigation, allows a modular construction, and avoids sensors already possibly provided in the vehicle from additionally having to be provided once again in the navigation apparatus.

The exemplary embodiment illustrated in FIG. 6 shows that—in addition to the output capability for graphic route guiding instructions on the display of the media player 1—additionally or alternatively, an output 11 of graphic route guiding instructions may occur via the display units 12 already provided in the vehicle. These may be TFT display screens installed in the vehicle or dot-matrix displays in the multipurpose instrument of the motor vehicle, for example.

FIG. 7 shows a schematic illustration of the sequence during operation of the navigation apparatus of FIG. 1 by the user.

The sequence shown relates to a navigation apparatus having a commercially available, unmodified media player 1, so that the associated navigation unit 2 is equipped with the two operating elements “A” and “B” in accordance with illustration in FIG. 1.

Firstly, the user connects the media player 1 to the navigation unit 2, in that the media player 1 is plugged into the counterpart on the navigation unit 2 compatible with the interface of the media player 1, cf. FIG. 1.

According to the right branch of the sequence shown in FIG. 7, the user first selects the operating element “A” for the subsequent start of the target input via the media player 1. The media player 1 is activated via the interface 5 using operating element “A” (function 1 in FIG. 7), and the navigation unit 2 is switched into the target input mode (function 3 in FIG. 7). Before the actual target input, the navigation software and the navigation databanks may also be checked for being current (function 2 in FIG. 7). The latter is shown in more extensive form in FIG. 8.

If a route guide initiated earlier is already active upon the actuation of the operating element “A” by the user, in this case, the actuation of the operating element “A” results in an interruption of the current route guide (function 4 in FIG. 7). Subsequently, either a changeover to media or music playback operation via the media player 1 may occur, while the current navigation is processed further in the background, or the current navigation may be stopped completely. This is in turn shown in detail in FIG. 10.

Therefore, after the media player 1 has been activated by the navigation unit 2 (function 1 in FIG. 7), the travel target lists are transmitted by the navigation unit 2 in the form of playlists to the display of the media player 1 (function 3), which is shown in detail in FIG. 9.

Following the completed target input by the user via the operating interface and the display of the media player 1 (function 3 in FIG. 7, cf. FIG. 9), the user selects the operating element “B” on the navigation unit 2, cf. left branch of the flowchart in FIG. 7. As a result, the travel target previously selected on the media player 1 (function 3) is accepted in the navigation unit 2, and route calculation and route guiding are initialized (function 5 in FIG. 7). The associated sequences during route calculation and route guiding are in turn shown in detail in FIG. 11.

FIG. 8 shows the sequence of checking the databanks for being current (cf. function 2 in FIG. 7).

FIG. 8 relates to an embodiment of the navigation apparatus in which the particular current version of the travel target databank, as well as version specifications and/or updates of the navigation software and the version number of the current street maps may be stored on the mass memory installed in the media player 1. This may be performed, for example, in that the user produces a connection to an online service of the navigation provider using media player 1 and/or personal computer 13 and retrieves the corresponding version information and/or updates (cf. FIGS. 12 and 13 for more detail in this regard).

The street maps themselves and the navigation software are not stored on the mass memory of the media player 1 in the exemplary embodiment on which FIG. 8 is based—in particular for space reasons—but rather on the memory card of the navigation unit 2. Alternately, a division of navigation software and map data between the mass memories of the media player 1 and the navigation unit 2 is also possible.

To perform the update, according to FIG. 8—following the activation of the databank check, cf. function 2 in FIG. 7—firstly the version numbers of the travel target databank, the navigation software, and the street maps are retrieved from the memory of the media player 1 by the communication manager of the navigation unit 2, and in a further step they are compared to the versions of the street maps and the navigation software present on the mass memory of the navigation unit 2.

If it results on the basis of the comparison of the version numbers of the current travel target databank on the media player 1 and the street maps stored on the navigation unit 2 that the current travel target databank is incompatible with the existing street maps, a corresponding message is output on the display of the media player 1. To be able to use the current travel target databank together with the street maps, an update of the street maps stored on the memory cards of the navigation unit 2 is first necessary in this case, see FIG. 13 in this regard.

If the travel target databank proves to be compatible with the street maps, it is subsequently checked whether the current version of the navigation software is already present in the navigation unit 2. If so, all relevant databanks and the software are compatible and the databank check is finished. If the version number of the navigation software present in the navigation unit 2 does not correspond to the version number stored on the media player 1, however, a message is displayed on the media player 1, after which the user may begin a corresponding software update.

If the query for the software update has been confirmed by the user (for example, by actuating a corresponding operating element on the media player 1, in other embodiments by pressing the button “B” of the navigation unit 2), the corresponding software updates present on the mass memory of the media player 1 are transmitted to the navigation unit 2. If the update has run successfully, the prior version of the navigation software is erased from the mass memory of the navigation unit 2, and a corresponding update confirmation is displayed on the display of the media player 1, after which the databank check is also finished.

The method steps for target input are shown in FIG. 9 (function 3 of FIG. 7), the target input being performed via the operating element of the media player 1.

After the activation of the target input, the software of the navigation apparatus first generates a graphic display of the corresponding target input interface and transmits this display illustration to the display of the media player 1.

The target input interface particularly comprises country, city, or street lists—and/or other lists of travel target such as points of interest or the like, for example—which are displayed in the form of typical playlists on the display of the media player 1.

Subsequently, the user selects the desired travel target in the way familiar from handling his music playlists by actuating the corresponding operating element of the media player 1. The selection of the travel target using playlist representation is illustrated in detail in FIGS. 15 through 20.

After the desired travel target has been selected, the travel target input is transmitted to the communication software of the navigation unit 2 as shown in FIG. 9.

FIG. 10 shows the flowchart for the case of interrupting the route guiding, or for the case of changing over to media playback (function 4 of FIG. 7).

If the user actuates the operating element “A” on the navigation unit 2 during a running navigation as shown in FIG. 7, this is interpreted as a request to interrupt the navigation, and the sequence in FIG. 10 is started.

Firstly, the graphic output of route guiding instructions via the display the media player 1 by the navigation unit 2 is stopped, and only the acoustic route guiding instructions of the running navigation are still transmitted to the media player 1 and/or to the vehicle loudspeakers 8. In other words, this means that the actual navigation is initially executed further by the navigation unit 2 in the background, and acoustic route guiding instructions are still output.

Subsequently, the media player 1 is changed over to media display, and the user may select media, particularly music titles for replay via the media player 1, in the familiar way, while the navigation is still executed in the background.

A further press on the button “A” of the navigation unit 2 in turn results in a change of the current display mode. In this case, the previously started media playback display and/or the music menu is thus erased from the display of the media player 1, and the navigation graphic is again displayed on the media player 1. However, the running music playback is not interrupted, so that the navigation display which is now active may occur with media playback and/or music still running in the background.

In contrast, if the button “B” is pressed, the current route guiding is canceled, so that subsequently, for example, a new travel target may again be input and a new route guiding may be started.

The method steps in the route calculation and in the output of the route guiding instructions are shown in FIG. 11 (according to function 5 in FIG. 7).

Accordingly—following the activation of the route calculation and guiding—firstly the tabular values of the travel target are read by the address input component of the navigation software in the navigation apparatus and provided to the route calculation component as the target address.

Subsequently, the current geographic position is ascertained by the localization component of the navigation software and provided to the route calculation component in the graphic component of the navigation software.

On the basis of the current geographic position and the target address, the navigation software of the navigation apparatus calculates the route from the current position to the target address. Using the calculated route, the route guiding component then generates the graphic and acoustic route guiding instructions, and provides these to the graphic display component and the audio driver.

The graphic display component generates a corresponding route guiding display screen on the basis of the graphic route guiding instructions. The route guiding display screen is generated in the media player graphic display format and stored in the temporary memory. In this way, it is ensured in the embodiment having a commercially available media player 1 that the media player 1 may display the route guiding display screen, although the media player 1 does not itself support any navigation display functions in this embodiment.

Subsequently, route guiding display screen and audio data are transmitted to the media player 1, after which the media player 1 displays the route guiding display screen and plays back the audio data. Further embodiments may be implemented in such a way that the media player 1 is also provided with text navigation instructions for display on the display screen of the media player 1 additionally or alternatively to the route guiding graphic.

The route output process is repeated as shown in FIG. 11 at regular intervals, for example, at second intervals, to refresh the route guiding display on the display of the media player 1 regularly and adapt it to the changes of the local position, and also to always be able to output the current acoustic route guiding instructions.

FIGS. 12 and 13 show two variants of the update procedure of the navigation-related data present with the user, cf. also FIG. 8 in this regard. According to FIG. 12, an online connection 14 to a server 15 of the navigation provider may be produced for this purpose via the personal computer 13 of the user. After the connection 14 is produced, update software installed on the personal computer compares the versions of the navigation software, the travel target lists, and the street maps between personal computer 13 and server 15 and/or between media player 1 and server 15. If a newer version of the navigation software, the travel target lists, and/or the street maps is provided on the server 15 of the provider, the newer version is downloaded and stored on the personal computer 13 and/or transferred to the media player 1.

For this purpose, the media player 1 may be connected via a docking station, a cable connection, or wireless connection to the personal computer, for example. The mass memory 16 next to the media player 1 in FIG. 12 is to symbolize the databanks stored on the media player 1. Furthermore, version information and files for the travel target lists, for the software of the navigation unit 2, and possibly update files for the street maps may be stored in the framework of the update on the media player 1 and/or on its mass memory 16.

The associated sequence during the update of software and street maps is shown in detail in FIG. 8.

FIG. 13 schematically illustrates an additional or alternative sequence in regard to the update of software and/or street maps. The flowchart in FIG. 13 differs from the flowchart in FIG. 12 in that the target of the update is not formed by the media player 1, but rather by a replaceable memory 17, for example, by a flash memory card, the mass memory symbol 18 symbolizing the databanks stored on the memory card.

This means that in the flowchart in FIG. 13, the version information and files 18 in regard to the target lists, the software of the navigation unit 2, and the street maps are compared between the replaceable memory 17 and the server 15 of the provider. The possibly required update of the files 18 on the memory 17 occurs in the same way as in FIG. 12, and thus also again corresponds to the extensive illustration in FIG. 8.

In particular in the embodiment of the present invention using a commercially available media player 1, both variants of the update process in FIG. 12 and FIG. 13 may possibly be used. Normally, the user will solely connect his media player 1 to the personal computer 13 and/or to the server 15 of the provider, in order not only to download media files such as music albums onto the media player 1 in this way, but rather also to thus keep his target lists stored on the media player 1 at the most current state, or to download additional target lists, for example, for other travel countries, from the provider server 15.

At this opportunity, the version information for the street maps and the software of the navigation unit 2, and possibly also update components for software and/or street maps, may also be downloaded and transferred to the media player 1. Upon a later reproduction of the connection between media player 1 and navigation unit 2, the internal version comparison between media player 1 and navigation unit 2 may occur and at least parts of the data and/or software present in the navigation unit 2 may be brought to the most current state on the basis of the update components stored in the media player 1.

The sequences in this regard are explained in detail in the illustration of FIG. 8 and in the associated sections of the description.

However, if there is not enough memory space for a possible update, in particular of the street maps, on the mass memory of the media player 1, the user may be requested by the update software to connect the replaceable memory of the navigation unit 2 to the personal computer instead of the media player 1, i.e., for example, to insert the memory card of the navigation unit 2 into a corresponding card reader on the personal computer. Subsequently, the update of the street maps may also be downloaded from the provider server and transferred to the memory card.

FIG. 14 schematically shows the configuration of the components used for route calculation in an embodiment of a navigation apparatus according to the present invention.

In addition to the data pool comprising the route planning data, e.g., travel target lists, and the street maps, the navigation apparatus from FIG. 14 comprises the route planner for the actual calculation of the route on the basis of the current location and on the basis of the input travel target, the instruction generator for generating the graphic, text, and/or acoustic route guiding instructions to be output, the data ascertainment unit for ascertaining and retrieving the necessary data from the street map, the positioning unit for ascertaining the current geographical position and comparing it to the current street map, and the rendering unit for generating the route guiding graphics.

The components are shown and situated in FIG. 14 independently of whether individual, multiple, or all of the components shown are housed in the navigation unit 2 or in the media player 1, for example.

FIGS. 15 through 20 illustrate the way in which the input of the desired travel target occurs on the media player 1. FIG. 15 and FIG. 16 show two different variants of the start display screen of the navigation, which are assigned to different embodiments.

FIG. 15 relates to the embodiment having a commercially available media player 1, in which the changeover between media playback operation and navigation operation is still performed by actuating the separate key “A”, which is situated on the navigation unit 2 (cf FIG. 1). This is necessary in this embodiment, because the commercially available media player 1 per se does not provide an independent changeover between media playback operation and navigation operation. Therefore, the media player 1 from FIG. 15, which is currently in navigation operation here, only shows menu items which relate to the navigation operation.

In contrast, FIG. 16 relates to an embodiment having a modified media player 1, in which software and/or hardware have already been sufficiently modified so that the changeover between media playback operation and navigation operation may occur directly via the operating interface of the media player 1, so that no separate actuating elements “A” or “B” are still necessary on the navigation unit 2. Therefore, the media player 1 from FIG. 16, which is currently in the overall function selection menu, shows menu items both in regard to the navigation function and also in regard to the media playback operation.

Independently of the observation of the embodiment from FIG. 15 or from FIG. 16, paging through target lists and selecting the desired target lists entry are performed as shown in FIGS. 17 through 20. Only the handling and preparation of the target lists displayed on the display of the media player 1, which occurs in the background, differs in the embodiments from FIG. 15 and FIG. 16. In the embodiment from FIG. 15 (commercially available media player), the navigation unit 2 completely assumes this handling and preparation of the target lists, in that it transmits the target lists to the media player 1 in the playlist format displayable by the media player 1. In the embodiment from FIG. 16 (modified media player), in contrast, handling and preparation of target lists may also be assumed by the media player 1 itself.

In both cases, firstly a country selection is displayed in FIG. 17 on the display of the media player 1. The user may make the desired selection from the offered countries using the operating elements of the media player 1 in exactly the same way which he typically uses for selecting music titles on the media player 1. After the selection of the target country, the user is successively offered city selection, street selection, and street number selection, cf. FIGS. 18 through 20. The user again selects the desired state, the desired street, and the street number of the travel target in the typical way as in a music playlist, and finally confirms the specification by the corresponding input element of the media player 1.

The route calculation and route guiding may be started following the target input thus performed, as shown in detail in FIG. 11 and the associated part of the description.

As a result, it is thus clear that thanks to the present invention a modular navigation apparatus is provided which particularly allows a combination of the two separate device and service species “navigation” and “personal multimedia”.

Thanks to the present invention, the field of use of multimedia playback devices may be increased to the field of navigation, in particular the operating interface familiar to the user and the familiar access to corresponding services of the service provider also being maintained for the area of application of navigation. Furthermore, hardware costs may be saved, and, upon use in a motor vehicle, an increase of safety and operating comfort may be achieved thanks to unifying devices and operating interfaces.

The present invention thus provides a fundamental contribution to improving the practicality, user friendliness, and cost effectiveness in the field of navigation devices, while simultaneously significantly expanding the area of use portable multimedia playback devices and associated online services.

1. A navigation apparatus, comprising a navigation unit (2), a position determination apparatus, a processor apparatus having an operating memory, a mass memory apparatus for receiving a databank, a display apparatus, an operating element configuration, a sound output apparatus, and navigation software receivable in the operating memory and/or in the processor apparatus,
wherein the display apparatus and operating element configuration are situated separately in a mobile multimedia playback device (1).

2. The navigation apparatus according to claim 1,
wherein navigation targets and associated control characters are converted into a list format compatible with the media replay list format of the multimedia playback device (1) and stored.

3. The navigation apparatus according to claim 1, comprising
an apparatus for converting a route guiding graphic into a graphic format compatible with the output graphic format of the multimedia playback device (1).

4. The navigation apparatus according to claim 1,
wherein the navigation unit (2) comprises an apparatus for transmitting the audio signal provided by the multimedia playback device (1) to an external loudspeaker system.

5. The navigation apparatus according to claim 1,
wherein the mass memory apparatus is situated in the multimedia playback device (1).

6. The navigation apparatus according to claim 1,
wherein the navigation unit (2) has a transmission interface (5) compatible with the standardized interface of the multimedia playback device.

7. The navigation apparatus according to claim 6,
wherein the transmission interface (5) is a wireless interface.

8. The navigation apparatus according to claim 1,
wherein the navigation unit (1) is installed in a motor vehicle.

9. The navigation apparatus according to claim 1,
wherein the navigation unit (1) has an operating element (A, B) for changing over the multimedia playback device (1) between media playback operation and navigation operation.

10. The navigation apparatus according to claim 9,
wherein the operating element (A, B) for changing over the multimedia playback device (1) between media playback operation and navigation operation is situated on a remote control unit.

11. The navigation apparatus according to claim 1,
wherein the multimedia playback device (1) is set up for simultaneous media playback operation and navigation operation.

12. The navigation apparatus according to claim 1,
wherein the navigation unit (2) is implemented as a holder for the multimedia playback device (1).

13. The navigation apparatus according to claim 1,
wherein the navigation unit (2) comprises a holder for the multimedia playback device (1) and a separate control unit.

14. The navigation apparatus according to claim 1,
wherein the processor apparatus and operating memory of the navigation apparatus are situated in the multimedia playback device (1).

15. A method for outputting navigation instructions of a navigation apparatus, the navigation apparatus comprising a navigation unit (2), a position determination apparatus, a processor apparatus having an operating memory, a mass memory apparatus, a display apparatus, an operating element configuration, a sound output apparatus, and navigation software receivable in the operating memory and/or in the processor apparatus, the display apparatus and operating element configuration of the navigation apparatus being situated in a separate mobile multimedia playback device (1), the method steps including:
a) provider-side provision of geographic datasets, in particular street maps, as well as target addresses, on a data carrier;
b) retrieval of a number of geographic datasets and/or target addresses from the data carrier using a user-side client system;
c) transmission of the retrieved geographic datasets and/or target addresses to the multimedia playback device (1);
d) display of a list of target addresses on the display of the multimedia playback device (1);
e) selection of a target address using the operating elements of the multimedia playback device (1) by the user;
f) transmission of the selected target address to the processor apparatus of the navigation apparatus;
g) generation of graphic and/or acoustic route guiding instructions using the navigation software; and
h) output of the graphic and/or acoustic route guiding instructions using the multimedia playback device (1).

16. The method according to claim 15,
wherein the geographic datasets are provided in method step a) on a data carrier of a provider-side computer server using an access service.

17. The method according to claim 15,
wherein in method step b), a set of geographic datasets and/or target addresses definable by the user is retrieved.

18. The method according to claim 15,
wherein access to and retrieval of the geographic datasets and/or target addresses in method step b) follows a personal identification of the user.

19. The method according to claim 15,
wherein the retrieval of the geographic datasets and/or target addresses in method step b) is fee-based as a function of the number of datasets retrieved.

20. The method according to claim 15,
wherein the retrieval of the geographic datasets and/or target addresses in method step b) is fee-based as a function of the number of datasets used.

21. The method according to claim 15,
wherein a scope of geographic datasets and/or target addresses is stored on the mass memory of the navigation apparatus, independently of downloads of the user, in method step e), only those stored datasets and/or target addresses being able to be selected by the user which were additionally contained and/or listed in a fee-based download of the user from the provider-side computer server.

22. The method according to claim 15,
wherein in method step b), there is a version number comparison of the geographic datasets, target address lists, and/or navigation software versions stored on the user-side client system and/or on the mobile multimedia playback device (1) with the version of the datasets, target address lists, and/or navigation software present at the provider, an update of the data and/or software present with the user being performed if necessary.

23. The method according to claim 15,
wherein the user-side client system is formed by a personal computer of the user, retrieval and transmission of the geographic datasets and/or target addresses in method step b) and c) being performed using the personal computer.

24. The method according to claim 15,
wherein the user-side client system is formed by the navigation unit (2), retrieval and transmission of the geographic datasets and/or target addresses in method step b) and c) being performed using the navigation unit (2).

25. The method according to claim 15,
wherein the geographic datasets and/or target addresses are converted by the provider into a playlist format of the multimedia playback device (1) and stored on the data carrier, and the datasets and/or target addresses are displayed in method step d) in the playlist format on the display of the multimedia playback device (1).

26. The method according to claim 15,
wherein the graphic route guiding instructions are generated in method step g) in a graphic format compatible with the output graphic format of the multimedia playback device (1).

27. The method according to claim 15,
wherein in method step a) additional geographic linked content is retrieved, in particular in regard to points of interest, events, and content related to user interests.
